(19) United States
(12) Patent Application Publication
(10) Pub. No.: US 2021/0270294 A1
(43) Pub. Date: Sep. 2, 2021

(54) A HYDRAULIC SYSTEM FOR A LOAD HANDLING VEHICLE

(71) Applicant: PARKER HANNIFIN EMEA S.A.R.L., Etoy (CH)

(72) Inventors: Andries Broekx, Genk (BE); Paul Leadly, Somerset (GB); Thomas McCann, Leeds (GB)

(21) Appl. No.: 17/259,376

(22) PCT Filed: Jul. 11, 2019
(86) PCT No.: PCT/EP2019/068769

§ 371 Date: Jan. 11, 2021

(30) Foreign Application Priority Data
Jul. 11, 2018 (GB) 1811366.2

(51) Int. Cl. F15B 13/04; B66F 9/22; F15B 11/042; F15B 21/14

(52) U.S. Cl. CPC F15B 13/0402; B66F 9/22; F15B 11/0423; F15B 21/14; F15B 2211/20569; F15B 2211/3057; F15B 2211/526; F15B 2211/327; F15B 2211/329; F15B 2211/88; F15B 2211/428; F15B 2211/426; F15B 2211/31588

(57) ABSTRACT

A hydraulic system (1, 50) for a load handling vehicle comprises lifting actuator (2, C1) that operates in a load lifting mode in which a load is induced on the actuator, and a load lowering mode in which the actuator provides hydraulic power PI to the hydraulic system. An auxiliary hydraulic actuator (4, 6, 8, C2) is also provided that has a hydraulic power demand P2. A hydraulic pump (10, 58) directs hydraulic power to the hydraulic lifting actuator and the at least one auxiliary hydraulic actuator. The hydraulic system is configured such that when the hydraulic lifting actuator is in the load lowering mode, it is required to simultaneously actuate the at least one auxiliary hydraulic actuator, and PI is greater than or equal to P2, hydraulic power may be channelled directly to the auxiliary hydraulic actuator from the hydraulic lifting actuator in order that the at least one auxiliary hydraulic actuator is actuated entirely by the hydraulic power from the hydraulic lifting actuator, and without the use of the pump.

The invention relates generally to a hydraulic system a load handling vehicle such as an electric forklift truck, order picker or the like. In particular this invention relates to a means of utilising the hydraulic energy from a hydraulic lifting actuator during load lowering for powering auxiliary hydraulic functionality.

Electric load handling vehicles such as electric forklift trucks or electric order pickers include an electrical drive means for providing motion to the vehicle and a hydraulic system for providing power to hydraulic actuators such as the lifting circuit of a forklift. An electric forklift truck includes a primary hydraulic actuator for vertically raising and lowering a load. The primary lifting actuator is driven by a hydraulic pump/motor via a primary hydraulic circuit. The primary hydraulic circuit will typically be arranged to provide pressurised hydraulic fluid directly to the primary actuator from the pump, as the primary hydraulic actuator operates under the greatest load pressure. In addition to the vertical raising and lowering of the load, a load handling vehicle will commonly include auxiliary hydraulic actuators for performing additional functions such and forward and rearward reach, or lateral and/or transverse tilt of the load.

It is known to provide electric load handling vehicles with the capacity for energy regeneration during hydraulic lowering of the load. In such systems the induced hydraulic pressure during load lowering may be used to drive the pump/motor to operate as a generator to produce electricity that may be used to drive the vehicle or stored in the vehicle battery.

The primary and auxiliary cylinders have differing and often simultaneous fluid supply demands. In current systems, if use of the auxiliary cylinder is demanded during load lowering the pump/motor must be operated to drive the auxiliary cylinders and cannot be used for electrical regeneration. The energy from the primary cylinder is lost to tank. It is known is certain systems to use the lowering load pressure to boost the pump/motor when operating the auxiliary cylinder, thereby enabling the pump/motor to be operated more efficiently. However, this does not efficiently recover the energy from the lowering load, and much of the energy is lost as heat.

It is therefore desirable to provide an improved method and system for recovering hydraulic energy in a lift truck, which enables efficient recovery of the energy from the primary hydraulic cylinder during load lowering while simultaneously operating one or more auxiliary cylinders and/or which offers improvements generally.

In an embodiment of the invention there is provided a hydraulic system for a load handling vehicle, the system comprising a hydraulic lifting actuator arranged and configured to operate in a load lifting mode, and a load lowering mode in which a load is induced on the main hydraulic actuator and the main hydraulic actuator provides hydraulic power P1 to the hydraulic system; at least one hydraulic actuator which, when operated, has a hydraulic power demand P2; and a hydraulic pump arranged to direct hydraulic power to the hydraulic lifting actuator and the at least one auxiliary hydraulic actuator. The hydraulic system is configured such that when the hydraulic lifting actuator is in the load lowering mode, it is required to simultaneously actuate the at least one auxiliary hydraulic actuator, and P1 is greater than or equal to P2, hydraulic power may be channelled directly to the at least one auxiliary hydraulic actuator from the hydraulic lifting actuator such that the at least one auxiliary hydraulic actuator is actuated entirely by the hydraulic power from the hydraulic lifting actuator and without the use of the pump. In this mode of operation, the pump is not required to drive the auxiliary actuator and no energy is drawn from the battery. The efficiency of the system is thereby improved by hydraulic regeneration of the hydraulic power of the induced load that would otherwise by wasted as heat to the hydraulic fluid as the load is lowered and the fluid from the lifting actuator is directed to tank.

The hydraulic pump is preferably a hydraulic pump/motor and is arranged receive hydraulic power from the hydraulic lifting actuator when the hydraulic lifting actuator is in the load lowering mode. Furthermore, the system may include a motor/generator and an electrical storage device. The motor/generator may be connected to the hydraulic pump/motor such that in a drive mode the motor/generator operates as a motor to provide power to the pump/motor to operate the pump/motor as a pump, and in a regeneration mode the pump/motor operates as a motor and drives the motor/generator to operate as a generator to generate electricity that is supplied to the energy storage device. As such, the hydraulic power from the lowering load may be used to provide electrical regeneration in addition to hydraulic regeneration where the operating parameters permit.

The hydraulic system is preferably configured such that when the hydraulic lifting actuator is in the load lowering mode and it is required to simultaneously actuate the at least one auxiliary hydraulic actuator, and P1 is greater than P2, the excess hydraulic power not required by the at least one auxiliary hydraulic actuator may be directed to drive the pump/motor in the regeneration mode. As such, hybrid regeneration is permitted in which excess hydraulic power not being used for hydraulic regeneration is used to drive electrical regeneration.

The hydraulic system preferably further comprises a reservoir tank and is configured such that when the hydraulic lifting actuator is in the load lowering mode and it is required to simultaneously actuate the at least one auxiliary hydraulic actuator, and P1 is greater than P2, and regeneration is not required, the excess hydraulic flow from the hydraulic lifting actuator not required by the at least one auxiliary actuator is channelled directly to the reservoir tank such that it avoids the hydraulic pump/motor.

The hydraulic system preferably further comprises a reservoir tank and is configured such that when the hydraulic lifting actuator is in the load lowering mode and it is required to simultaneously actuate the at least one hydraulic actuator, and P1 is less than P2, hydraulic flow from the hydraulic lifting actuator is channelled directly to the reservoir tank such that it avoids the hydraulic pump/motor and the hydraulic pump/motor is operated in the drive mode to actuate the at least one hydraulic actuator.

The hydraulic system preferably further comprises a lifting valve arranged to control the flow of hydraulic fluid to and from the hydraulic lifting actuator, wherein when the hydraulic flow from the hydraulic lifting actuator is channelled directly to the reservoir tank the lifting valve is operable to variably restrict the flow of fluid to the reservoir tank from the hydraulic lifting actuator to control the lowering speed of the hydraulic lifting actuator.

Preferably when the hydraulic lifting actuator is in the load lowering mode and operation of the at least one auxiliary hydraulic actuator is not required, all the hydraulic power P2 is directed to drive the pump/motor in the regeneration mode.

Preferably when it is required to simultaneously operate the hydraulic lifting actuator in the load lifting mode and operate the at least one auxiliary cylinder, both are driven by the pump/motor which operates as a pump in the drive mode.

The hydraulic system preferably further comprises a lifting valve for controlling flow to and from the hydraulic lifting actuator and an auxiliary valve for controlling flow to and from the auxiliary hydraulic actuator, wherein when the hydraulic lifting actuator and auxiliary hydraulic actuator are being driven by the pump/motor simultaneously and the load on the hydraulic lifting actuator is greater than the load on the auxiliary hydraulic actuator the auxiliary valve is throttled to create sufficient backpressure to enable the hydraulic lifting actuator to operate simultaneous with the auxiliary hydraulic actuator.

Preferably when the hydraulic lifting actuator and auxiliary hydraulic actuator are being driven by the pump/motor simultaneously and the combined speed of the hydraulic lifting actuator and auxiliary hydraulic actuator exceeds the maximum speed of the pump/motor, operation of one of the hydraulic lifting actuator and auxiliary hydraulic actuator is prioritized and allowed to continue at the required speed while flow to the other is throttled to reduce the combined speed to a level equal to or below the speed range of the pump/motor.

Preferably when the hydraulic lifting actuator is in the load lowering mode and it is required to simultaneously actuate the at least one auxiliary hydraulic actuator, and P1 is greater than P2, but the lowering speed of the hydraulic lifting actuator is less than the demand speed of the auxiliary hydraulic actuator, the hydraulic flow from the hydraulic lifting actuator may be channelled directly to the reservoir tank such that it avoids the hydraulic pump/motor and the hydraulic pump/motor is operated in the drive mode to actuate the at least one hydraulic actuator.

In another embodiment of the invention there is provided a hydraulic system for a load handling vehicle, the system comprising a hydraulic lifting actuator arranged and configured to operate in a load lifting mode, and a load lowering mode in which a load is induced on the main hydraulic actuator; at least one hydraulic actuator; and a hydraulic pump arranged to direct hydraulic power to the hydraulic lifting actuator and the at least one auxiliary hydraulic actuator. The hydraulic system is configured such that when the hydraulic lifting actuator is in the load lowering mode, and it is required to simultaneously actuate the at least one auxiliary hydraulic actuator, the induced load on the hydraulic lifting actuator may be used to operate the at least one auxiliary hydraulic actuator.

In another aspect of the invention there is provided a load handling vehicle, such as a forklift truck, comprising a hydraulic system as described above.

In another aspect of the invention there is provided a method of operating a hydraulic system for a load handling vehicle comprising a hydraulic lifting actuator arranged and configured to operate in a load lifting mode in which a load is induced on the actuator, and a load lowering mode in which the main hydraulic actuator provides hydraulic power P1 to the hydraulic system; at least one hydraulic actuator which, when operated, has a hydraulic power demand P2; and a hydraulic pump arranged to direct hydraulic power to the hydraulic lifting actuator and the at least one auxiliary hydraulic actuator; wherein when the hydraulic lifting actuator is in the load lowering mode and it is required to simultaneously actuate the at least one auxiliary hydraulic actuator, and P1 is greater than or equal to P2, the method comprises actuating the at least one auxiliary hydraulic actuator by channelling hydraulic power directly to the at least one auxiliary hydraulic actuator from the hydraulic lifting actuator such that the at least one auxiliary hydraulic actuator is actuated entirely by the hydraulic power from the hydraulic lifting actuator.

The method preferably comprises channelling excess hydraulic power not required by the at least one auxiliary hydraulic actuator to drive a pump/motor in the regeneration mode to generate electricity when the hydraulic lifting actuator is in the load lowering mode and it is required to simultaneously actuate the at least one auxiliary hydraulic actuator, and P1 is greater than P2.

The method preferably comprises channelling excess hydraulic flow from the hydraulic lifting actuator not required by the at least one auxiliary actuator directly to a reservoir tank such that it avoids the hydraulic pump/motor reservoir tank when the hydraulic lifting actuator is in the load lowering mode and it is required to simultaneously actuate the at least one auxiliary hydraulic actuator, and P1 is greater than P2, and electrical regeneration is not required.

The method preferably comprises channelling hydraulic flow from the hydraulic lifting actuator directly to the reservoir tank such that it avoids the hydraulic pump/motor and operating the hydraulic pump/motor in a drive mode to actuate the at least one hydraulic actuator when the hydraulic lifting actuator is in the load lowering mode and it is required to simultaneously actuate the at least one hydraulic actuator, and P1 is less than P2.

The method preferably comprises operating a lifting valve to variably restrict the flow of fluid to the reservoir tank from the hydraulic lifting actuator to control the lowering speed of the hydraulic lifting actuator when the hydraulic flow from the hydraulic lifting actuator is channelled directly to the reservoir tank

The method preferably comprises directing all the hydraulic power P2 to drive the pump/motor in the regeneration mode when the hydraulic lifting actuator is in the load lowering mode and operation of the at least one auxiliary hydraulic actuator is not required.

The method preferably comprises operating the pump in a drive mode to drive both the hydraulic lifting actuator and the at least one auxiliary cylinder wherein when it is required to simultaneously operate the hydraulic lifting actuator in the load lifting mode and operate the at least one auxiliary cylinder.

Preferably the hydraulic system includes a lifting valve for controlling flow to and from the hydraulic lifting actuator and an auxiliary valve for controlling flow to and from the auxiliary hydraulic actuator and the method comprises throttling the auxiliary valve to create sufficient backpressure to enable the hydraulic lifting actuator to operate simultaneously with the auxiliary hydraulic actuator when the hydraulic lifting actuator and auxiliary hydraulic actuator are being driven by the pump/motor simultaneously and the load on the hydraulic lifting actuator is greater than the load on the auxiliary hydraulic actuator.

The method preferably comprises prioritizing the operation of one of the hydraulic lifting actuator and auxiliary hydraulic actuator and allowed said prioritized operation to continue at the required speed and at the same time throttling flow to the other to reduce the combined speed to a level equal to or below the speed range of the pump/motor when the hydraulic lifting actuator and auxiliary hydraulic actuator are being driven by the pump/motor simultaneously and the combined speed of the hydraulic lifting actuator and auxiliary hydraulic actuator exceeds the maximum speed of the pump/motor.

The method preferably comprises channelling the hydraulic flow from the hydraulic lifting actuator directly to the reservoir tank such that it avoids the hydraulic pump/motor and operating the hydraulic pump/motor in the drive mode to actuate the at least one hydraulic actuator when the hydraulic lifting actuator is in the load lowering mode and it is required to simultaneously actuate the at least one auxiliary hydraulic actuator, and P1 is greater than P2, but the lowering speed of the hydraulic lifting actuator is less than the demand speed of the auxiliary hydraulic actuator.

A control valve assembly for use in the above hydraulic system comprises a load handling vehicle such as forklift. The control valve comprises a valve body having a bore and a spool located within the bore that is axially movable along the bore between at least two operating configurations. A service port is formed in the valve body and arranged for connection to a hydraulic consumer such as a hydraulic actuator. A pressure port is also formed in the valve body and arranged for connection to a hydraulic power provider such as a pump. In addition, a tank port is formed in the valve body and arranged for connection to a hydraulic tank reservoir. The valve is reconfigurable between a first and second operating configurations. In the first operating configuration the spool is configured and arranged to define a fluid pathway connecting the pump port, the service port and the tank port such that in a first flow direction fluid is able to flow from the pressure port to the service port and the tank port, and in a second flow direction fluid is able to flow from the service port to the pressure port and the tank port, and the spool is controllable to variably restrict flow to the tank port. In the second operating configuration the spool is configured and arranged to close the tank port and define a fluid pathway connecting the pressure port and the actuator port, and the spool is controllable to variably restrict flow between the pressure port and the actuator port.

The first mode of operation enables off-load pump start-up wherein the pump is operated without being loaded by the lifting pressure. The tank port may be fully opened on start-up so there is no hydraulic restriction and the pump therefore operates without a load. This arrangement avoids the need for a separate bypass valve as can be found in arrangements of the prior art. In addition, the ability to operate the spool to variably restrict the tank port in the first operating configuration enables flow to the actuator to be initiated, while also allowing flow to tank for excess fluid not required when the flow demand of the actuator is less than the output flow of the pump when operating at the minimum operating speed recommended by the manufacturer. By incorporating the functions provided by the first and second operating configurations in a single spool valve significant improvements are provided over the arrangements of the prior art which utilise multiple cartridge valves and significantly more complex control systems to provide the same functionality.

At the point the flow demand of the hydraulic actuator becomes greater than or equal to the minimum output flow of the pump the spool may then be operated in the second operating configuration in which flow to tank is closed and flow to the actuator controlled by controlling the speed of the pump. The second operating configuration may also be used during lowering where flow through the pump is required for the purpose of energy regeneration. The ability to operate the spool in the second operating configuration to variably restrict flow between the pressure port and the service port enables the flow from the actuator to the pump to be controlled.

Preferably the valve is reconfigurable to a third operating configuration in which the spool is configured and arranged to close the pressure port and define a fluid pathway between the service port and the tank port, and the spool is controllable to variably restrict flow between the service port and the tank port. This advantageously enables gravity lowering with flow from the actuator directly to tank. The ability to variably restrict the flow path allows the lowering speed to be controlled. The incorporation of the functionality achieved in the third operating configuration into the spool valve provides yet further advances over the prior art and removes the requirement for the additional valve and control arrangements that would be otherwise employed in the prior art to achieve the same functionality.

The spool is preferably configured such that in the first operating configuration the flow path between the pressure port and the service port remains fully open when flow to the tank port is variably restricted.

Preferably a controller is provided for controlling the axial position of the spool. The controller is therefore configured to move the spool between the first, second and third operating configurations.

The control valve assembly may further comprise biasing means arranged to bias the spool to the first operating configuration. The first operating configuration with the tank port fully open is therefore the default rest position of the spool. The controller operates the spool against the action of the biasing member to move the spool to variably restrict the tank port in the first operating configuration and to move the spool into the second and third operational configurations.

Preferably in a first supply mode of operation in which the spool is arranged in the first operating configuration during activation of the pump the tank port is open to permit flow from the pressure port to the tank port during pump activation. This corresponds to the full off-load start up position, with no flow going to the actuator.

In a second supply mode of operation, in which the spool is in the first operating configuration, the controller is configured to control the spool to proportionally close the tank port to share flow between the actuating port and the tank port when flow to the actuating port is initiated and the required supply flow to the actuator is less than the minimum supply flow of the pump. In this situation flow from the pump exceeds the actuator demand. Flow commences to the actuator and excess flow is directed to tank.

In a third supply mode of operation the controller may be configured to arrange the spool in the second operating configuration to close the tank port such that all flow from the pressure port is directed to the actuating port when the required supply flow to the actuator is equal to or greater than the minimum supply flow of the pump.

The controller is preferably configured to control the pump to increase in speed once the tank port is fully closed and the required supply flow to the actuator is greater than the minimum supply flow of the pump.

In a fourth supply mode of operation the controller is preferably configured to arrange the spool in the second operating configuration and to proportionally close the flowpath between the pressure port and the service port to throttle flow to the actuator from the pump when the required system pressure exceeds the required supply pressure to the actuator. This provides a simple and efficient means of enabling auxiliary actuators to be operated at a higher pressure than the primary actuator

In a fifth regenerative lowering mode of operation the controller may be configured to control the spool to move to the second operative configuration to allow fluid to flow from the actuator to the pump. In this arrangement the tank port is closed and a direct flowpath between the actuator and pump is created.

In the fifth regenerative lowering mode the controller is configured to control the spool to proportionally close the fluid flowpath between the pressure port and the service port to throttle flow from the actuator to the pump. This enables flow to the pump to be restricted to prevent overload of the battery during energy regeneration.

Preferably, in a sixth gravity lowering mode of operation the controller is configured to arrange the spool in the third operative configuration to allow fluid to flow directly from the service port to the tank port when energy regeneration via the pump is not required.

In the sixth gravity lowering mode of operation the controller may be configured to control lowering of the actuator by controlling the spool to proportionally close the fluid flowpath between the service port and tank port to throttle flow from the actuator to the tank.

The valve body preferably includes a pilot port arranged to receive pressurised fluid for controlling movement of the spool valve. The supply of pressurised fluid to the pilot port is controlled by the controller.

The control valve assembly may further comprise a proportional pressure reducing valve connected to the pilot port for controlling the fluid pressure at the pilot port. The proportional pressure reducing valve is controlled by the controller to control the supply of pressurised fluid to the pilot port.

The spool preferably includes a loading surface at a first end arranged such that pressurised fluid entering the pressure port applies a force to said loading surface to cause axial movement of the spool in a first direction and the biasing means is located at a second end of spool and arranged to impart a biasing force to the spool in an axially opposing second direction.

There may also be provided a hydraulic control system for a load handling vehicle. The system comprises a hydraulic actuator; a pump; a tank reservoir; and a valve assembly as described above. The pump is fluidly connected to the pressure port of the valve, the hydraulic actuator is connected to the service port and the tank reservoir is connected to the tank port.

There may also be provided a method of flow control for a load handling vehicle comprising a first hydraulic actuator; a pump; a tank reservoir; and a valve assembly as described above. The pump is fluidly connected to the pressure port of the valve, the hydraulic actuator is connected to the service port and the tank reservoir is connected to the tank port. The method comprises selectively moving the spool axially along the bore between said three operating configurations.

The method may further comprise, in a first supply mode of operation, activating the pump with the spool arranged in the first operating configuration such that the tank port is open to permit flow from the pump to the tank during pump activation.

The method preferably comprises, in a second supply mode of operation, controlling the spool to proportionally close the tank port following activation of the pump to share flow between the actuator and the tank when the required supply flow to the actuator is less than the minimum supply flow of the pump.

The method preferably comprises, in a third supply mode of operation, controlling the spool when in the first operating configuration to close the tank port and directing all flow from the pump to the actuator when the required supply flow to the actuator is equal to or greater than the minimum supply flow of the pump.

The method preferably comprises increasing the speed of the pump when the tank port is fully closed and the required supply flow to the actuator is greater than the minimum supply flow of the pump.

The load handling vehicle preferably further comprises at least a second hydraulic actuator supplied with fluid by the pump, the method further comprising, in a fourth supply mode of operation, arranging the spool in the second operating configuration and controlling the spool to proportionally close the flowpath between the pressure port and the service port to throttle flow to the first actuator from the pump when the pressure required by the second actuator exceeds the required supply pressure to the first actuator.

The method may further comprise, in a fifth regenerative lowering mode of operation, arranging the spool in the second operative configuration to allow fluid to flow from the actuator to the pump.

The pump is preferably a pump generator, and the method may further comprise driving the pump generator using said fluid flow from the actuator and operating the pump generator to generate electricity.

The method may further comprise controlling lowering of the actuator by proportionally closing the fluid flowpath between the pressure port and the service port to throttle flow from the actuator to the pump.

The method may further comprise controlling the spool in a sixth gravity lowering mode of operation to arrange the spool in the third operative configuration to allow fluid to flow from the service port to the tank port when energy regeneration is not required.

The method may further comprise controlling lowering of the actuator by controlling the spool to proportionally close the fluid flowpath between the service port and tank port to throttle flow from the actuator to the tank.

The valve body preferably includes a pilot port and the method further comprises supplying pressurised fluid to the pilot port to control movement of the spool.

The present invention will now be described by way of example only with reference to the following illustrative figures in which:

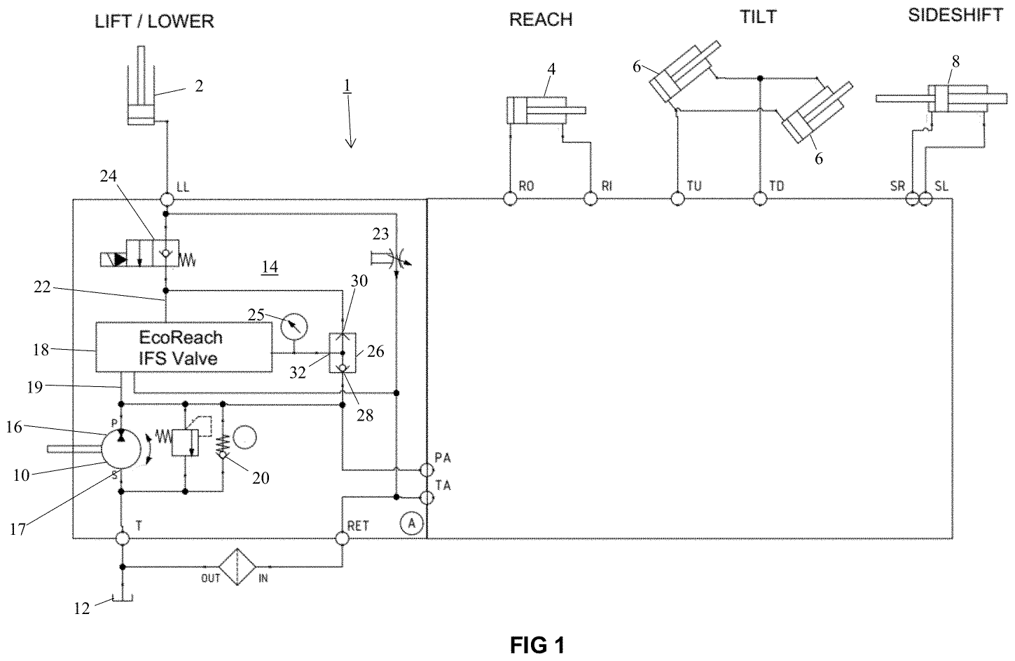

FIG. 1 is a circuit diagram of a hydraulic system;

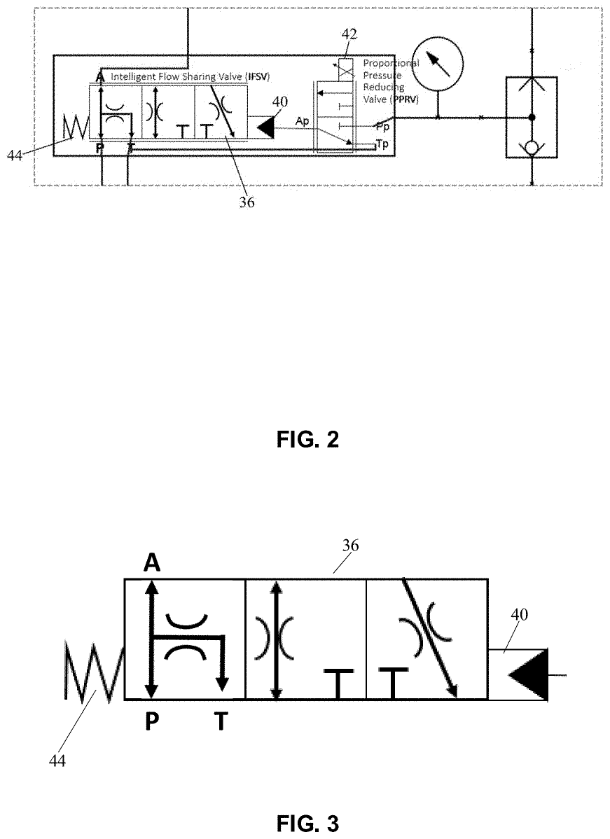

FIG. 2 is a schematic diagram of a valve for use an a hydraulic system of the present invention;

FIG. 3 is a schematic diagram of the valve in a first operative configuration;

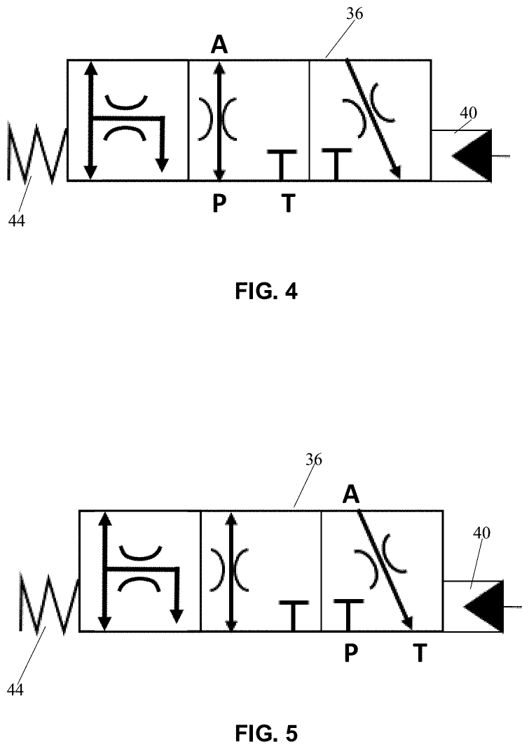

FIG. 4 is a schematic diagram of the valve in a second operative configuration; and

FIG. 5 is a schematic diagram of the valve in a third operative configuration;

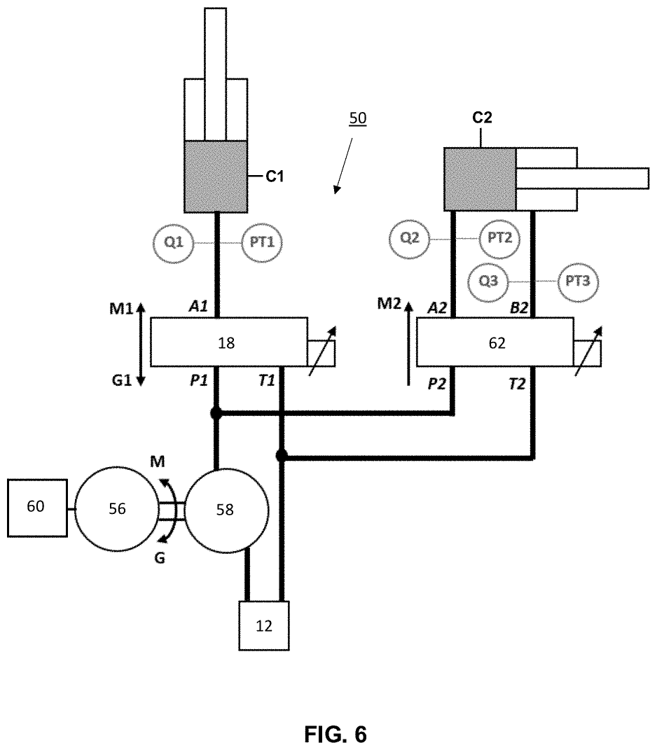

FIG. 6 is a schematic diagram of a hydraulic system according to the present invention; and

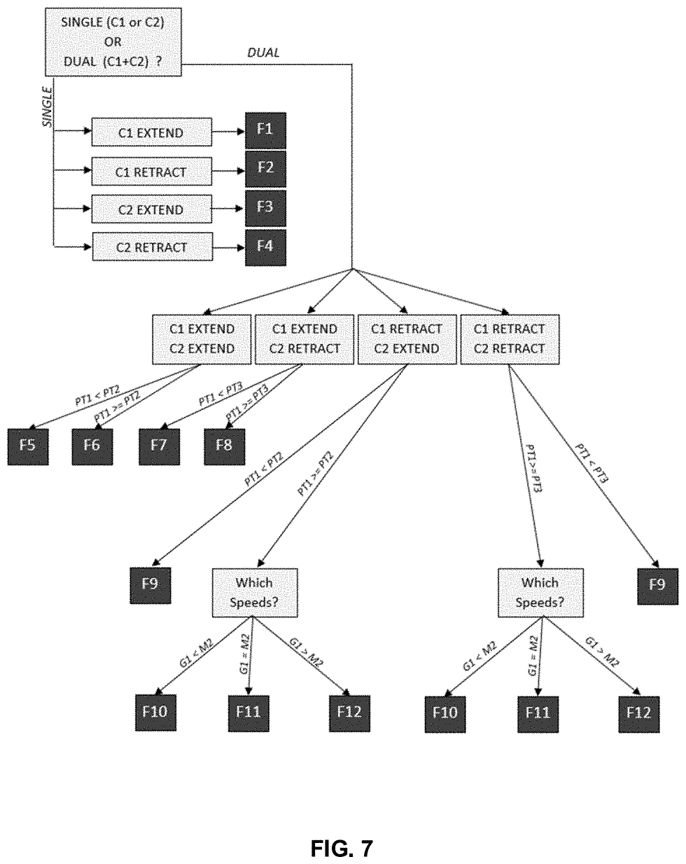

FIG. 7 is an operational flow chart for the hydraulic system of FIG. 6.

FIG. 1 is a hydraulic circuit 1 for a load handling vehicle such as a forklift truck. The circuit comprises a primary hydraulic actuator 2 which in use in connected to lifting tines of the forklift truck, which are movably mounted to the mast of the vehicle. The circuit also includes a first auxiliary hydraulic actuator 4 which is arranged to perform a reach function in which the tines are moved forwards and backwards relative to the mast.

Second auxiliary hydraulic cylinders 6 are arranged to tilt the mast of the vehicle to vary the angle of the load in the forwards and backwards direction. A third auxiliary hydraulic cylinder 8 is arranged to move the tines laterally side to side relative to the mast. It will be appreciated that this is an example of one arrangement of auxiliary functions, and that the circuit may include additional, or fewer auxiliary hydraulic cylinders depending on the operational requirements of the vehicle.

A pump motor 10 is provided to operate the primary and auxiliary hydraulic cylinders. In a supply mode of operation the pump motor 10 is configured to provide hydraulic flow/pressure to the hydraulic system 1 by rotating in a first supply direction and converting mechanical shaft power from the electric motor into hydraulic power. The pump motor 10 is also configured to operate in a regeneration mode in which it receives hydraulic flow/pressure from the system, causing the pump to rotate in a second regeneration direction. Hydraulic power is converted into mechanical shaft power, which is able to be converted to electrical energy. This bi-directional pump arrangement is referred to as a 2 Quadrant pump. The hydraulic system 1 further includes a tank reservoir 12.

A first manifold 14 is configured to control flow to the primary hydraulic cylinder 2 from the pump 10. Second and third manifolds 15 and 17 are also provided for controlling flow to the auxiliary hydraulic cylinders. The first manifold 14 includes a first pressure port 16 and second pressure port 17. In the supply mode, the first pressure port 16 is the outlet port of the pump 10, and the second port 17 is the pump inlet, supplying flow to the pump 10 from the tank 12. The first pressure port 16 is connected to spool valve 18, which is configured to intelligently share flow, via flow channel 19. The spool valve 18 controls flow to the first hydraulic actuator 2 from the pump 10. The spool valve 18 is connected to the first hydraulic actuator 2 via flow channel 22. A hydraulic load-holding valve 24 is provided between the spool valve 18 and the first hydraulic actuator 2. The valve 24 is configured to operate in a deactivated position and an activated position. In the de-activated position the valve 24 blocks flow from the first hydraulic actuator 2 to the spool valve 18 while allowing flow in the reverse direction from the spool valve 18 to the first hydraulic actuator 2. This enables the load on the first hydraulic actuator 2 to be held in position. In the activated position flow is able to pass from the first hydraulic actuator 2 to the pump 10 or tank 12.

An anti-cavitation check valve 20 is provided in the first manifold as a safety feature. The fluid circuit also includes an emergency lowering valve 23 which is configured to provide throttled flow from the first hydraulic actuator 2 to tank 12 to safely lower the load in case of a system failure, such as an electrical failure in the control system.

A hydraulic pressure transducer 25 is provided to measure the load pressure on the forks. The hydraulic pressure transducer 25 may also be used as an input to the control system in order to further advance the control algorithms and optimize the activation/de-activation of certain hydraulic valves. A hydraulic shuttle valve 26 is also provided having inlet ports 28 and 30 and an outlet port 32. The valve 26 shuttles the highest pressure from the two inlet ports 28 and 30, from the pump 10 or first hydraulic actuator 2 respectively, to the outlet port 32, which supplies the spool valve 18.

FIG. 2 is an illustrative schematic view of the spool valve 18. The valve 18 comprises a valve body having an axial bore, and a spool 36 contained within the bore. The spool 36 is axially movable within the bore. Three operating configurations are schematically represented within spool 36 which illustrate the flow conditions in each of three operating positions corresponding to different axial positions of the spool along the bore relative to the pressure port P, service port A and tank port T. The spool valve 18 is pilot operated, and a pilot port 40 is provided at a first axial end of the spool 36 which is arranged to receive fluid from the outlet 32 of the shuttle valve 26. Flow to the pilot port 40 is controlled by a proportional pressure reducing valve (PPRV) 42, which proportionally varies the pressure at the pilot port 40 based on an electronic control signal provided to a coil within the valve 42.

The PPRV 42 is controlled by a controller operating a control algorithm configured to control the position of the spool 36 based on the flow demands and current operating parameters of the hydraulic system. The pressure at the pilot port 40 acts on the spool 36 to axially move the spool 36 in a first axial direction away from the pilot port 40. A biasing member 44 is provided at the opposing end of the spool 36, which is arranged to provide a biasing force in the opposing axial direction to the pilot pressure. The biasing member 44 may be a compression spring or any suitable biasing means. The biasing member 44 biases the spool 36 in a second axial direction towards the pilot port. In order to move the spool 36 in the first direction towards the biasing member 44 the pilot pressure must overcome the biasing spring force of the biasing member 44.

The valve body 34 comprises a pressure port P, which is connected to the pump 10 via the flow channel 19, a service port A connected to the first hydraulic actuator 2 via flow channel 22, and tank port T connected to the tank reservoir 12. The spool 36 is configured to move axially under the control of the pilot signal between three different operating positions. The spool 36 is configured to define different flow pathways between the ports P,A,T in the three operating positions.

In a first operating position shown in FIG. 3, the spool 18 is configured and arranged to define a fluid pathway connecting the pressure port P, the service port A and the tank port T. In the first position all three ports are connected such that in a first flow direction fluid is able to flow from the pressure port P to the service port A and the tank port T, and in a second flow direction fluid is able to flow from the service port A to the P and the tank port T. The spool 18 is controllable by the pilot signal when in the first position to variably restrict flow to the tank port T, as will be further described below.

In the first position the spool 36 functions in a first mode of operation to facilitate off-load pump start up. In a hydraulic system it is desirable for the hydraulic pump to start up ‘off-load’, meaning that the pump is not loaded by the lifting pressure while it begins to rotate. As such the hydraulic pump can be rotated to a certain speed before the load pressure is introduced and gradually increased. In arrangements of the prior art this is commonly achieved using bypass valves, but the inclusion of additional bypass valves add cost and complexity to the hydraulic system. Due to the cost competitive nature of the forklift industry the bypass valves are often left out of the hydraulic system. As a result, the hydraulic pumps are started on-load, without any gradual introduction of the load, which leads to premature wear of the hydraulic pump.

The first mode of operation of the spool valve 36 is controlled such that the pressure port P, tank port T and service port A are open. As such, when the pump 10 is initiated and begins to rotate, there is no load on the pump 10 as the fluid is able to flow to tank 12. As the first hydraulic actuator 2 is loaded, there is no flow to the service port A despite the port being open. With the tank port T fully open there is no hydraulic restriction and the pump 10 operates without a load. Enabling the pump 10 to start off-load in this way provides the same functionality as a separate bypass valve. The hydraulic pump 10 can be increased in the first mode of operation to a minimum rotational speed, for example a rotational speed correlating to an output flow of 5 lpm, without loading, due to all of the output flow being diverted to tank 12.

Following pump activation, with the pump 10 running at a speed corresponding to the minimum operating speed recommended by the pump manufacturer, flow to the first hydraulic actuator 2 via the service port A may be initiated. Output flow on service port A may be provided under two conditions. The first condition is where the flow demand of the first hydraulic actuator 2 is less than the minimum output flow of the pump 10, and the second being where the flow demand of the first hydraulic actuator 2 is greater than or equal to the minimum output flow of the pump 10. The spool 36 is operable under the control of the pilot signal to satisfy the flow demand under both conditions.

In a second mode of operation, as shown in FIG. 4, in which the pump 10 is running at a speed corresponding to the minimum operating speed recommended by the pump manufacturer and the required output flow on the service port A is less than minimum output flow, i.e. the bypassing flow (going back to port T), the full flow from the pump 10 exceeds the demand on the service port A and therefore the full flow of the pump 10 cannot be directed to the service port A.

The spool 36 is therefore controlled to proportionally close the tank port T such that the required flow is redirected to the service port A and the excess flow is continuing to flow to the tank port T. In this way the spool 36 operates the tank port T as a variable bleed orifice between the pressure port P and tank port T. Proportional closure of the tank port T creates flow sharing between port A and T, with port P as the inlet or flow supply. The spool 36 is controllable by the pilot signal to proportionally vary the degree to which the tank port T is closed depending on the actuator demand.

In the second mode of operation the flow to service port A is controlled between zero and the minimum output flow of the pump 10, e.g. from 0 to 5 LPM. This enables a creep speed of the forks in which the actuator flow at service port A is significantly less than the minimum required output flow (minimum rotational speed) of the pump 10 without causing damage to the pump. For example, the minimum rotational speed of an external gear pump under full load may be 500 RPM; the speed being set to ensure sufficient lubrication of the bearings to prevent damage. In typical forklifts a pump displacement of 23.0 cc/rev can be used. At 500 RPM this will give a theoretical output flow of 11.5 LPM. If the required output flow at the service port A is less than 11.5 LPM and the pump is caused to operate at this speed it may wear out prematurely.

In a third operating mode, at the point where flow to the service port A equals the minimum flow of the pump 10, the tank port T is able to be fully closed. Once the required output flow on service port A is equal to or greater that the minimum output flow of the pump 10, flow to the tank 12 is no longer required. The control algorithm of the controller will begin to control the spool 36 to proportionally shift the inlet flow provided on port P from the bypass flow to tank port T to actuator flow at service port A.

Once all the supply flow on pressure port P is redirected to service port A, and the tank port T is fully closed, flow to the service port A is controlled entirely by the speed of the pump 10. If the flow demand at the service port A exceeds the minimum output flow of the pump 10, the speed of the pump 10 will be increased in order to increase flow to the service port A.

In a second operating position, shown in FIG. 4, the spool 36 is configured such that a flow channel is defined between the pressure port P and the service port A, and the tank port T is closed. The spool 36 is controlled by the pilot signal to proportionally close the pressure port P and/or the service port A to create a control orifice between the pump 10 and first hydraulic actuator 2. As such, the spool 36 may be controlled to proportionally throttle flow between the pressure port P and service port A. In a fourth operating mode, throttling of the flow between the pressure port P and service port A may be implemented when flow sharing conditions are demanded between the first hydraulic actuator 2 and one or more of the auxiliary actuators 4,6,8. Without throttling, the hydraulic oil provided by the hydraulic pump will always choose the path of least resistance. Therefore, when flow to an auxiliary cylinder 4,6,8 is required at a pressure that exceeds the flow demand of the first actuator 2, flow to the first actuator 2 must be throttled to enable the system pressure to be raised to the level of the auxiliary demand pressure.

As an example, if the first actuator 2 requires 100 bar in order to lift the loaded forks, but the auxiliary cylinder 4 requires 150 bar to operate the reach function, in the absence of any flow sharing logic all the oil provided by the pump 10 will be directed to the lift function of the first hydraulic actuator 2. This results in the lift function over-speeding unexpectedly, whilst the reach function will not operate at all. In most hydraulic systems this is highly undesirable, and when simultaneous function is required some flow sharing logic needs to be built into the circuit. However, the additional components required for flow sharing capability typically results in a more complex and expensive system. In the fourth operating mode of the present invention flow sharing is achieved by controlling the spool 36 to throttle flow to the service port A in order to raise the system pressure to the auxiliary demand pressure. In the above example this would require the application of a 50 bar throttle to the flow to the service port A, such that pump operates at 150 bar while supply to the service port A is 100 bar. This results in 50 bar of throttling losses over the IFS spool valve 18, but enables simultaneous primary and auxiliary function (i.e. lift and reach) with the use of a single pump and without the requirement for complex and expensive additional valves and control systems.

In most flow sharing circuits the flow sharing is achieved by load-sense logic, which controls a pilot-operated logic element that can throttle the pressure differential across itself by varying the pilot signal. In a hydraulic system there will always be a pressure drop from the pump outlet port to the point in the system where the load-sense signal will be picked up. In order to off-set this pressure drop a spring bias needs to be introduced in the logic element in order for it to remain closed when not required. In some systems the bias spring force might need to be as high as 20 bar. Although operation of these valves is fairly simple, they have one major drawback. When simultaneous function is not required, to maximize the system efficiency the pressure drop through the logic element needs to be minimized. In the present invention, a bias spring is not necessary because the valve position can be throttled directly by spool 36 under the control of the pilot signal. As a bias spring is not required the valve can be positioned to its fully open position when simultaneous function is not required, resulting in a significant increase in system efficiency.

In the second operating position the flow direction may be reversed to provide flow from the service port A to the pressure port P. The spool 36 is operable to throttle the flow between the pressure port P and service port A bi-directionally, and can therefore throttle flow when flowing from the service port A to the pressure port P in the same manner as described above for flow from the pressure port P actuator to the port A. which means to throttle from port P to A as well as from A to P.

In a fifth mode of operation, flow may be provided from service port A to the pressure port P to enable the pressurised fluid from the first hydraulic actuator 2 to be used during lowering to drive the pump 10 for energy regeneration, in which the pump motor 10 operates as a hydraulic motor, converting hydraulic power into mechanical shaft power. Under these conditions it is desirable to be able to controllably initiate load to the pump 10, for example if the hydraulic unit is driven by an electric motor/generator such as an induction motor that has poor dynamic performance. The spool valve 18 enables initial lowering of the forks to be achieved in a fully hydraulic manner using the spool 36 to throttle flow from the service port A to the pressure port P. During this gravity lowering phase rotation of the electric motor/generator may be initiated unloaded, allowing torque to be ramped up before the gradual initiation of the regenerative motor/generator unit. More generally the use of the spool valve 18 allows improved controllability, especially when creep-speed lowering is desired.

The pump motor 10 may be used to generate electrical energy during regenerative lowering that is stored in a battery. During regenerative lowering the kinetic energy from the hydraulic fluid pressurised by the elevated load is converted from electrical energy by driving the pump motor 10 as a generator unit. Under certain operating conditions, such as where the forklift is predominantly lowering loads with limited lifting operation, the battery may become fully charged as energy regeneration exceeds electric energy consumption. Once the state of charge of the battery pack is 100%, overcharging may cause damage to the battery. In this scenario, the lowering flow may be throttled such that load is removed from the pump motor 10 to cease energy regeneration. The spool valve 18 therefore provides battery overcharge protection, whilst enabling the load to be lowered in a safe and controlled manner. In arrangements of the prior art, the hydraulic systems require separate logic element valves in order to enable throttling from the service port A to the pressure port P as such logic element valves can only be controlled unidirectionally, which again requires additional components and adds complexity and cost to the system.

In a sixth mode of operation, in the second operating position, the flow channel from the service port A to the pressure port P may be fully opened. Fully opening the flow channel from the service port A to the pressure port P minimises pressure drop through the spool valve 18 and maximises system efficiency. By controlling the spool 36 such that the flow channel from service port A to pressure port P is in its fully open state, all the kinetic energy available from the load can be used by the motor/generator for electric energy recovery, which maximises the energy saving potential compared to systems of the prior art.

In a third operating position, as shown in FIG. 5, the spool 36 is configured such that a flow channel is defined between the service port A and the tank port T, and the pressure port P is closed. The spool 36 is controlled by the pilot signal to proportionally close the tank port T and/or the service port A to create a control orifice between the tank 12 and first hydraulic actuator 2. As such, the spool 36 may be controlled to proportionally throttle flow between the service port A and the tank port 12 during lowering of the load.

The third operating position provides a more conventional gravity lowering means of lowering a load, without energy regeneration. During gravity lowering all the available kinetic energy is converted into heat in the oil by throttling the induced pressure down to atmospheric pressure by controlling the orifice in-between the service port A and tank port T. All flow from the first hydraulic actuator 2 goes directly to tank 12 rather than through the pump 10. Although very inefficient compared to the energy recovery mode of operation, there are specific advantages that may be achieved by gravity lowering in the third operating position.

The heat energy generated by flow throttling during gravity lowering is generally undesirable as heating up the hydraulic oil requires a more powerful cooling system on the hydraulics. However, in cases when the forklift trucks are used in a cold storage environment it might be feasible to switch back to a highly efficient system in order to use the kinetic energy from lowering to bring the hydraulic oil temperature into its operating zone as quick as possible. If energy recovery systems are implemented in forklift trucks the energy from lowering a load will be converted into useful electric energy, which inherently reduces the amount of heat transferred to the oil.

As described above, in certain circumstances regenerative lowering is not possible due to the battery being fully charged. Instead of throttled gravity lowering in the second operating position and free spinning the hydraulic pump 10, the spool valve 18 can be switched to the third operating position in which the lowering flow is throttled down directly to the tank 12. In this way the pump 10 does not need to be rotated, which reduces operation of the pump 10 and minimises system noise.

In a further advantage, the IFS valve of the present invention enables operation of the auxiliary cylinders during lowering, without the requirement for 4 Quadrant pump technology. During lowering of the first hydraulic cylinder 2 a simultaneous auxiliary function such as ‘reach’ may be required. The pump 10 is used during regenerative lowering to capture the available kinetic energy and use it to charge the batteries. If a simultaneous auxiliary function is required during a regenerative lowering event the induced load on the first hydraulic cylinder 2 may be used to operate the auxiliary functions if the pressure is sufficient to meet the auxiliary demand. However, if the induced pressure on the first hydraulic cylinder 2 is not sufficient, the pump 10 will be required to operate the auxiliary functions. It is possible to operate a pump to boost the pressure from the lowering cylinder as the lowering flow passes through the pump by loading the return line of the pump. However, this requires a change in pump technology from 2Q (2 quadrant) to 4Q (4 quadrant) which significantly increases cost and complexity and limits the pump technologies that can be used in such energy recovery systems. In the present invention, where pump operation is required to supply the auxiliary cylinders during load lowering, the spool 36 may be moved to the third position to enable flow from first actuator 2 to tank 12, which bypasses the pump 10 and enables the pump 10 to be operated to supply the auxiliary demand.

FIG. 6 shows a simplified schematic of a hydraulic circuit 50 incorporating the intelligent flow sharing spool valve 18. The system includes a main actuator cylinder C1 and a second actuator cylinder C2. The main cylinder C1 is a single acting lifting actuator cylinder in which the working fluid acts on one side of the piston only to lift a load. In the reverse direction lowering of the load is actuated by the weight of the load. The auxiliary actuator cylinder C2 is a double acting actuator cylinder in which the working fluid acts alternately on both sides of the piston.

The system includes a powertrain comprising an electric motor/generator 56, a hydraulic pump/motor 58 and an energy storage device 60, such as a battery. The motor/generator 56 and pump/motor 58 can work in a forward direction, indicated by direction arrow M, and a reverse direction indicated by direction arrow G. In the forward direction M the motor/generator 56 consumes energy from an energy storage device 60. In the reverse direction G the motor/generator 56 is driven by the pump/motor 58 and generates electrical energy that is put back into the energy storage device 60.

The flow of hydraulic fluid to and from the main actuator cylinder C1 is controlled by spool valve 18. However, while the spool valve provides the most effective and efficient means of controlling the main actuator cylinder C1 it will be appreciated that other valve means or a combination of valve means may be used. Flow of hydraulic fluid to and from the auxiliary actuator cylinder C2 is controlled by a second hydraulic control valve 62. The spool valve 18 has three ports—pressure port P1, service port A1 and return port T1. The pressure port P1 of the valve 18 is supplied by the pump/motor 58. The service port A1 supplies the main actuating cylinder 56, and the return port T1 is connected to the hydraulic tank reservoir 12. The spool valve 18 only requires a single service port A1 due to the main actuator cylinder C1 being a single acting cylinder working against gravity. Extending of main actuator cylinder C1 is achieved by feeding hydraulic fluid to the main actuator cylinder C1 via service port A1. Retracting the main actuator cylinder C1 is achieved by a gravity induced reverse flow through the same port A1.

The second hydraulic control valve 62 has 4 hydraulic ports—a pressure port P2, a return port T2 and two controlled service ports A2 and B2, which are required to operate the cylinder in both directions. The auxiliary cylinder C2 has two ports 66,68. The first port 66 is connected to the first service port A2 and the second port 68 is connected to the second service port. The pressure feed port P2 is supplied by the pump/motor 58 and the return port T2 is connected to tank 12. going back to the hydraulic reservoir (T) and a two controlled output ports (A2 and B2) going to actuator C2. To extend the auxiliary cylinder C2, fluid is supplied to the first port 66 via the first service port A2. Fluid flows from the second port 68 to the return port T2 via the second service port B2. To retract the tank the auxiliary cylinder C2, fluid is supplied to the second port 68 via the second service port B2. Fluid flows from the first port 66 to the return port T2 via the first service port A2.

The spool valve 18 and second hydraulic control valve 62 can be proportionally controlled to vary the degree to which flow through the valves is restriction. For the spool valve 18 it is possible to proportionally restrict the flow path between the pressure port P1 and service port A1 for flows in both directions. It is also possible to variably restrict the flow between service port A1 and return port T1. The second hydraulic control valve 62 can controlled to proportionally restrict flow from P2 to A2 or P2 to B2, depending on whether the auxiliary cylinder C2 is to be extended or retracted respectively. The system includes means for determining the flow Q1 going to the main actuating cylinder C1 and pressure PT1 required to operate main actuating cylinder C1. This may comprise data acquisition devices in the form of a flow sensor 70 and pressure sensor 72. Similarly, flow sensors 74,76 and pressure sensors 78,80 may be provided to determine the flow and pressure requirements of the ports of the auxiliary cylinder C2. The motor speed required to operate the main actuator cylinder C1, and the reverse regenerative motor speed generated by the lowering flow from the main actuator cylinder C1 are indicated by arrow directions M1 and G1 respectively. The motor speed required to operate the auxiliary cylinder C2 is indicated by arrow M2. M1, G1 and M2 combine as variables that determine the equivalent operating speed of the motor for a given function. For example, if the main actuator cylinder C1 and auxiliary cylinder C2 were operated simultaneously at a certain speed, the total motor speed M would be the product of M1 and M2 i.e. M=M1+M2.

If the auxiliary function actuated by the auxiliary actuator cylinder C2 is required when the load on the main actuator cylinder C1 is being lowered, the pressure generated by the induced load on the main actuator cylinder C1 may be used to operate the auxiliary functions if the pressure is sufficient to meet the auxiliary demand. Depending on the load requirement of the auxiliary actuator cylinder C2, some or all of the hydraulic power from the induced load of the main actuator cylinder C1 may be directed to the auxiliary actuator cylinder C2 to power the auxiliary actuator cylinder C2. Where the hydraulic power exceeds the requirements of the auxiliary actuator cylinder C2, the excess power may be directed to the pump/motor 58 for electrical energy regeneration.

If the main actuator cylinder C1 was operated in the lowering energy recovery mode with a lower speed G1, the total motor speed M would be dependent on the total of the lowering speed G1 of the main actuator cylinder C1, which is a reverse flow through the pump, and the speed M2 of the auxiliary actuator cylinder C2. Therefore M=−G1+M2. If the speed M2 is greater than G1 i.e. the energy recovery flow from the main actuator cylinder C1 is less than the required flow for auxiliary cylinder C2, the motor would spin in a positive direction M=−G1+M2 and energy would be taken out of the battery (E+). If M2<G1 i.e. the required flow for C2 is less then what is being recovered from C1, the electric motor would spin in a reverse direction (G) where G=−G1+M2.

A flowchart is provided in FIG. 7 illustrating the various functional modes of operation of the hydraulic system 50, as described below.

Function F1

The operator requests a single function, in which the main actuator cylinder C1 (indicated as C1 in FIG. 7) needs to extend; this will typically a lift condition. The spool valve 18 will be fully open allowing flow from P1 to A1. Therefore, the extension speed of the main actuator cylinder C1 will be directly controlled by the speed of the motor/generator 56, which is run as a motor, and the pump/motor, which is run as a pump. The second hydraulic control valve 62 will be fully closed, and hence flow to the auxiliary actuator cylinder C2 is prevented.

Energy is drawn from the battery 60 by the motor/generator 56 proportionally to the speed command and the load that is being lifted.

Function F2

The operator requests a single function, in which the main actuator cylinder C1 needs to retract i.e. a lowering condition. The main actuator cylinder C1 retraction speed will be directly controlled by running the motor/generator 56 as a generator and pump/motor 58 as a motor in speed control. The extension speed of the main actuator cylinder C1 will be controlled with the fluid path from A1 to P1 fully open. With no throttling, energy losses are minimised. The second hydraulic control valve 62 will be fully closed, and hence flow to the auxiliary actuator cylinder C2 is prevented.

All of the potential energy from the lowering load that is regenerated into electrical energy, which is proportional to the lowering speed command and the magnitude of the gravity induced load that is being lowered. None of the potential energy is re-directed elsewhere in the circuit as hydraulic power, and as such this function can be considered to be full electric energy regeneration.

Function F3

The operator requests a single function, in which the auxiliary actuator cylinder C2 needs to extend (usually an auxiliary function condition such as reach, tilt or side shift). The extension speed of the auxiliary actuator cylinder C2 will be directly controlled by running the motor/generator 56 as a motor and pump/motor 58 as a pump in speed control. The spool valve 18 is controlled to be fully closed to prevent flow from P1 to A1 and the second hydraulic control valve 62 is fully open allowing flow from P2 to A2. Again, the fully open condition minimises energy losses. In some scenarios P2 to A2 might be throttled to create sufficient back pressure for the load, which might be required to prevent a load from overrunning or improve function stability.

The energy that is drawn from the battery 60 is proportional to the speed command and the load being moved by the auxiliary actuator cylinder C2, as well as some potential additional throttling losses in said scenarios.

Function F4

The operator requests a single function, in which the auxiliary actuator cylinder C2 needs to retract (usually an auxiliary function condition such as reach, tilt or side shift), the retraction speed of the main actuator cylinder will be directly controlled by running the motor/generator 56 as a motor and pump/motor 58 as a pump in speed control. The spool valve 18 is controlled to be fully closed to prevent flow from P1 to B1 and the second hydraulic control valve 62 is fully open allowing flow from P2 to B2. Again, the fully open condition minimises energy losses. In some scenarios P2 to B2 might be throttled to create sufficient back pressure for the load, which might be required to prevent a load from overrunning or improve function stability.

Function F5

The operator requests a dual, simultaneous function, in which both the main actuator cylinder C1 and the auxiliary actuator cylinder C2 need to extend. This will typically be a lift condition together with an auxiliary function condition such as reach, tilt or side shift. The valve control will depend on the load conditions induced on the main actuator cylinder C1 and the auxiliary actuator cylinder C2.

If the load on the main actuator cylinder C1 is lower than the load induced on auxiliary actuator cylinder C2 (PT1<PT2), the spool valve 18 is throttled from P1 to A1 to create sufficient backpressure to operate simultaneous function. If this was not the case, the oil would take the path of least resistance which results in the auxiliary actuator cylinder C2 not being operational and the main actuator cylinder C1 overrunning faster than the input command.

The second hydraulic control valve 62 is controlled to be fully open (P2 to A2) to minimise energy losses. If required, P2 to A2 could be throttled to create sufficient back pressure for the load, for example to prevent a load from overrunning or to improve function stability.

The speed of the main actuator cylinder C1 and the auxiliary actuator cylinder C2 will be controlled by running the motor/generator 56 as a motor and the pump/motor 58 as a pump in speed control. The total speed M of the motor 56 will be the combination of both partial speed commands M1 and M2, therefore M=M1+M2.

Providing M1+M2 stays below the maximum allowable speed for the pump/motor 58 to run at, both functions C1 and C2 will operate at the requested speed. Where M1+M2 exceeds this maximum speed, priority will be given to either the main actuator cylinder C1 or the auxiliary actuator cylinder C2 by varying the throttle command on the spool valve 18. Usually, but not necessarily, the auxiliary actuator cylinder C2 will be prioritised, which means its speed remains unaffected. This operation can be referred to as flow-shared lifting with throttled lift operation.

The energy that is drawn from the battery 60 is proportional to the combined speed command and the load being moved by the main actuator cylinder C1 and auxiliary actuator cylinder C2, as well as some potential additional throttling losses in said scenarios.

Function F6

The operator requests a dual simultaneous function, in which both the main actuator cylinder C1 and the auxiliary actuator cylinder C2 need to extend i.e. a lift condition together with an auxiliary function condition such as reach, tilt or side shift. The valve control will depend on the load conditions induced on the main actuator cylinder C1 and the auxiliary actuator cylinder C2.

If the load on the main actuator cylinder C1 is higher than or equal to the load induced on the auxiliary actuator cylinder C2 (PT1>=PT2), the second hydraulic control valve 62 is throttled from P2 to A2 to create sufficient backpressure to operate simultaneous function. If this was not the case, the oil would take the path of least resistance which results in C1 not being operational and the auxiliary actuator cylinder C2 overrunning faster than the input command.

The spool valve 18 is controlled to be fully open (P1 to A1) to minimise energy losses. P1 to A1 can be throttled if required in order to create sufficient back pressure for the load, for example if it is necessary to prevent a load from overrunning or improve function stability.

The speed of the main actuator cylinder C1 and the auxiliary actuator cylinder C2 will be controlled by running the running the motor/generator 56 as a motor and the pump/motor 58 as a pump in speed control. The total speed of the motor M will be the combination of both partial speed commands M1 and M2, therefore M=M1+M2. Providing M1+M2 stays below the maximum allowable speed for the P/M to run at, both functions C1 and C2 will operate at the requested speed. Where M1+M2 exceeds this maximum speed, priority will be given to either the main actuator cylinder C1 or the auxiliary actuator cylinder C2 by varying the throttle command on the spool valve 18. Usually, but not necessarily, the auxiliary actuator cylinder C2 will be prioritised, which means its speed remains unaffected. This operation can be referred to as flow-shared lifting with throttled auxiliary operation.

The energy that is drawn from the battery 60 is proportional to the combined speed command and the load being moved by the main actuator cylinder C1 and auxiliary actuator cylinder C2, as well as some potential additional throttling losses in said scenarios.

Function F7

In case the operator requests a dual (simultaneous) function, in which the main actuator cylinder C1 needs to extend and the auxiliary actuator cylinder C2 needs to retract i.e. a lift condition together with an auxiliary function condition such as reach, tilt or side shift.

The valve control will depend on the load conditions induced on the main actuator cylinder C1 and the auxiliary actuator cylinder C2.

If the load on the main actuator cylinder C1 is lower than the load induced on the auxiliary actuator cylinder C2 (PT1<PT3), spool valve 18 is throttled from P1 to A1 to create sufficient backpressure to operate simultaneous function. If this was not the case, the oil would take the path of least resistance which results in the auxiliary actuator cylinder C2 not being operational and the main actuator cylinder C1 overrunning faster than the input command.

The second hydraulic control valve 62 is controlled to be fully open (P2 to B2) to minimise energy losses. P2 to B2 might be throttled if required to create sufficient back pressure for the load, for example if it is necessary to prevent a load from overrunning or improve function stability.

The speed of the main actuator cylinder C1 and the auxiliary actuator cylinder C2 will be controlled by running the running the motor/generator 56 as a motor and the pump/motor 58 as a pump in speed control. The total speed of the motor M will be the combination of both partial speed commands M1 and M2, therefore M=M1+M2. Providing M1+M2 stays below the maximum allowable speed for the pump/motor 58 to run at, both functions C1 and C2 will operate at the requested speed. Where M1+M2 exceeds this maximum speed, priority will be given to either the main actuator cylinder C1 or the auxiliary actuator cylinder C2 by varying the throttle command on the spool valve 18. Usually, but not necessarily, the auxiliary actuator cylinder C2 will be prioritised, which means its speed remains unaffected. This operation can be referred to as flow-shared lifting with throttled lift operation.

The energy that is drawn from the battery 60 is proportional to the combined speed command and the load being moved by the main actuator cylinder C1 and auxiliary actuator cylinder C2, as well as some potential additional throttling losses in said scenarios.

Function F8

The operator requests a dual simultaneous function, in which the main actuator cylinder C1 needs to extend and the auxiliary actuator cylinder C2 needs to retract i.e. a lift condition together with an auxiliary function condition such as reach, tilt or side shift. The valve control will depend on the load conditions induced on the main actuator cylinder C1 and the auxiliary actuator cylinder C2.

If the load on the main actuator cylinder C1 is higher than or equal to the load induced on the auxiliary actuator cylinder C2 (PT1>=PT3), the second hydraulic control valve 62 is throttled from P2 to B2 to create sufficient backpressure to operate simultaneous function. If this was not the case, the oil would take the path of least resistance which results in the main actuator cylinder C1 not being operational and the auxiliary actuator cylinder C2 overrunning faster than the input command.

The spool valve 18 is controlled to be fully open (P1 to A1) to minimise energy losses. P1 to A1 might be throttled as well to create sufficient back pressure for the load, for example to prevent a load from overrunning or improve function stability. The speed of the main actuator cylinder C1 and the auxiliary actuator cylinder C2 will be controlled by running the running the motor/generator 56 as a motor and the pump/motor 58 as a pump in speed control. The total speed of the motor M will be the combination of both partial speed commands M1 and M2, therefore M=M1+M2. Providing M1+M2 stays below the maximum allowable speed for the pump/motor 58 to run at, both functions C1 and C2 will operate at the requested speed. Where M1+M2 exceeds this maximum speed, priority will be given to either the main actuator cylinder C1 or the auxiliary actuator cylinder C2 by varying the throttle command on the spool valve 18. Usually, but not necessarily, the auxiliary actuator cylinder C2 will be prioritised, which means its speed remains unaffected. This operation can be referred to as flow-shared lifting with throttled auxiliary operation.

The energy that is drawn from the battery 60 is proportional to the combined speed command and the load being moved by the main actuator cylinder C1 and auxiliary actuator cylinder C2, as well as some potential additional throttling losses in said scenarios.

Function F9

The operator requests a dual simultaneous function, in which the main actuator cylinder C1 needs to retract and the auxiliary actuator cylinder C2 needs to extend i.e. a lowering condition together with an auxiliary function condition such as reach, tilt or side shift. The valve control will depend on the load conditions induced on the main actuator cylinder C1 and the auxiliary actuator cylinder C2.

If the load on the main actuator cylinder C1 is lower than the load induced on the auxiliary actuator cylinder C2 (PT1<PT2 or PT1<PT3), the load on the main actuator cylinder C1 is insufficient to feed the auxiliary actuator cylinder C2. In this scenario the system will revert to a “conventional hydraulic system” where the induced load from the main actuator cylinder C1 is throttled down and diverted to tank 12. This is usually referred to as gravity lowering and is achieved by proportionally controlling the spool valve (port A1 to T1). All the potential energy induced is transferred into heat in the oil. The auxiliary actuator cylinder C2 is controlled as described in Function F3 and function F4, depending if you are extending (F3) or retracting (F4) auxiliary actuator cylinder C2. The energy that is drawn from the battery 60 is proportional to the combined speed command and the load being moved by the auxiliary actuator cylinder C2, as well as some potential additional throttling losses in said scenarios. The load and speed of the main actuator cylinder C1 does not affect the energy consumption/regeneration through the electrohydraulic powertrain. Instead, the potential energy induced on the main actuator cylinder C1 will be throttled down through the spool valve 18 to tank, wasting all the energy into heat in the hydraulic oil. This operation can be referred to as flow-shared lowering with gravity lowering.

Functions F10 to F12

The operator requests a dual simultaneous function, in which the main actuator cylinder C1 needs to retract and the auxiliary actuator cylinder C2 needs to extend i.e. a lowering condition together with an auxiliary function condition such as reach, tilt or side shift.

The valve control will depend on the load conditions induced on the main actuator cylinder C1 and the auxiliary actuator cylinder C2, as well as the speed commands for the main actuator cylinder C1 and the auxiliary actuator cylinder C2.

If the load on the main actuator cylinder C1 is higher than or equal to the load induced on the auxiliary actuator cylinder C2 (PT1>=PT2), second hydraulic control valve 62 is throttled from P2 to A2 to create sufficient backpressure to operate simultaneous function controllably. If this was not the case, the oil would “uncontrollably” flow from the main actuator cylinder C1 into the auxiliary actuator cylinder C2 and if the induced loads are significantly different this can result in dangerous and overly fast operation of C2. The spool valve 18 is controlled to be fully open (A1 to P1) to minimise energy losses.

The speed of the main actuator cylinder C1 and the auxiliary actuator cylinder C2 will be controlled by running the running the motor/generator 56 as a generator and the pump/motor 58 as a motor in speed control. The total speed of the motor M will be the combination of both partial speed commands G1 and M2, therefore M=G1+M2. There are 3 scenarios for the speed control, when the PT1 is greater than PT2.

Function F10

The first option the main actuator cylinder C1 retraction speed G1 is lower than the auxiliary actuator cylinder C2 extension speed M2. Even though the induced pressure would be sufficient to feed C2 directly, as the main actuator cylinder C1 retraction speed command is too slow, it would impact the C2 extension speed. Therefore, the control system may revert to a conventional system, in which the spool valve 18 is used to throttle the load from A1 to T1 and waste the energy as heat. This may be referred to as flow-sharing with temporary hydraulic energy waste.

Alternatively, in a second option the induced pressure and flow from the main actuator cylinder C1 (i.e. the C1 power) may be used to directly drive the auxiliary actuator cylinder C2. In this scenario the second hydraulic control valve 62 is throttled (P2 to A2) and the spool valve 18 is fully open (A1 to P1) to maximise energy regeneration. This operation may be referred to as flow-sharing with 100% hydraulic energy recovery.

Whether the first or second option is chosen depends on the end-user and both can be implemented using the same hardware. If energy savings are most critical then then the second option would be preferable. However, if productivity is more crucial then the first alternative would be a better choice. It is also possible to change the control algorithm “on-the-fly” depending on state of charge of the battery.

In the first option, energy will be taken out of the battery 60 proportionally to the speed command and load being moved by the auxiliary actuator cylinder C2, as well as some potential additional throttling losses in said scenarios. The load and speed of C1 does not affect the energy consumption/regeneration through the electrohydraulic powertrain and the motor/generator 56 runs as a motor driving the P/M as a pump (P).

In the second option, no energy will be taken out of the battery 60 as the load and speed induced on the main actuator cylinder C1 directly feeds the auxiliary actuator cylinder C2, but the auxiliary actuator cylinder C2 will run slower than usual. The motor/generator 56 is not used to drive C2. This operation is referred to as flow-shared lowering with limited auxiliary speed operation and 100% hydraulic energy recovery.

Function F11

This function relates to a scenario where the retraction speed G1 of the main actuator cylinder C1 is equal to the extension speed M2 of the auxiliary actuator cylinder C2. In this scenario the hydraulic power from the main actuator cylinder C1 is transferred directly to the auxiliary actuator cylinder C2. The auxiliary actuator cylinder C2 is actuated entirely by the hydraulic power from the main actuator cylinder C1. No energy is taken out from the battery 60 as the load and speed induced on the main actuator cylinder C1 directly matches and feeds the speed of the auxiliary actuator cylinder C2. Some throttling may be provided by the second hydraulic control valve 62 to match the two loads and prevent overrunning. The motor/generator 56 is not used to drive either the main actuator cylinder C1 retraction speed nor the auxiliary actuator cylinder C2 extension speed. The main actuator cylinder C1 retraction speed is controlled by the throttling of by the second hydraulic control valve 62 to extend C2.

This function is referred to as flow-shared lowering with perfectly matched speed auxiliary operation and 100% hydraulic energy recovery.

Function F12

This function relates to a scenario where the retraction speed G1 of the main actuator cylinder C1 is greater than the extension speed M2 of the auxiliary actuator cylinder C2. In this scenario the hydraulic power from the main actuator cylinder C1 is again transferred directly to the auxiliary actuator cylinder C2. The auxiliary actuator cylinder C2 is actuated entirely by the hydraulic power from the main actuator cylinder C1. No energy is taken out from the battery 60 as the load and speed induced on the main actuator cylinder C1 exceeds the power requirements of the auxiliary actuator cylinder C2. The speed of the auxiliary actuator cylinder C2 is controlled by throttling the second hydraulic control valve 62, which channels hydraulic fluid directly from the main actuator cylinder C1 into the auxiliary actuator cylinder C2, which is the hydraulic energy recovery part of the operation. The speed of the main actuator cylinder C1 exceeds the extension or retraction speed of the main actuator cylinder C2. Therefore, the excess hydraulic fluid not required by the auxiliary actuator cylinder C2 is directed to the pump/motor 58 to drive the motor/generator 56 as a generator to regenerate electrical energy that is stored in the battery 60.

This function is referred to as flow-shared lowering with combined/hybrid electric and hydraulic energy recovery.

The control algorithms of the hydraulic system controller constantly monitor the command requests from the operator and the system conditions of the main actuator cylinder C1 and the auxiliary actuator cylinder C2. The controller can be programmed to make intelligent decisions to switch between the above functions to optimise energy efficiency or productivity depending on the load available. The controller is able to switch between different operating modes “on-the-fly”. For example, the operator may begin to lower a load in a single operation corresponding to F2. Subsequently, an auxiliary command might be added. Depending on the load on the main actuator cylinder C1 the controller will either switch to function F9 or F10/F11/F12 depending on the speed commands. If for example the operator provided a slow the main actuator cylinder C1 retraction command and a fast auxiliary actuator cylinder C2 extension command, this would require function F10. As soon as the main actuator cylinder C1 retraction speed command increases the system can switch to F11 and F12 if so required. If the auxiliary actuator cylinder C2 reaches the end of stroke, the auxiliary actuator cylinder C2 command becomes invalid and the system would revert to function F2. During all of these switches in command and control algorithm functionality the retraction of auxiliary actuator cylinder C1 has been consistent, but the energy flow path has switched from full electric energy recovery (F2) to full hydraulic energy recovery (F10/F11), to hybrid electric and hydraulic energy recovery (F12) back to full electric energy recovery (F2).

1. A hydraulic system for a load handling vehicle, the system comprising
a hydraulic lifting actuator arranged and configured to operate in a load lifting mode and a load lowering mode in which the main hydraulic actuator provides hydraulic power P1 to the hydraulic system;
at least one auxiliary hydraulic actuator which, when operated, has a hydraulic power demand P2;
a hydraulic pump arranged to direct hydraulic power to the hydraulic lifting actuator and the at least one auxiliary hydraulic actuator;
wherein the hydraulic system is configured such that when the hydraulic lifting actuator is in the load lowering mode and it is required to simultaneously actuate the at least one auxiliary hydraulic actuator, and P1 is greater than or equal to P2, hydraulic power may be channelled directly to the at least one auxiliary hydraulic actuator from the hydraulic lifting actuator such that the at least one auxiliary
hydraulic actuator is directly actuated by the hydraulic power from the hydraulic lifting actuator.

2. A hydraulic system according to claim 1 wherein the hydraulic pump is a hydraulic pump/motor and is arranged receive hydraulic power from the hydraulic lifting actuator when the hydraulic lifting actuator is in the load lowering mode.

3. A hydraulic system according to claim 2 further comprising a motor/generator and an electrical storage device, and the motor/generator is connected to the hydraulic pump/motor such that in a drive mode the motor/generator operates as a motor to provide power to the pump/motor to operate the pump/motor as a pump, and in a regeneration mode the pump/motor operates as a motor and drives the motor/generator to operate as a generator to generate electricity that is supplied to the energy storage device.

4. A hydraulic system according to claim 3 wherein the hydraulic system is configured such that when the hydraulic lifting actuator is in the load lowering mode and it is required to simultaneously actuate the at least one auxiliary hydraulic actuator, and P1 is greater than P2, the excess hydraulic power not required by the at least one auxiliary hydraulic actuator may be directed to drive the pump/motor in the regeneration mode.

5. A hydraulic system according to claim 3 wherein the hydraulic system further comprises a reservoir tank and is configured such that when the hydraulic lifting actuator is in the load lowering mode and it is required to simultaneously actuate the at least one auxiliary hydraulic actuator, and P1 is greater than P2, and regeneration is not required, the excess hydraulic flow from the hydraulic lifting actuator not required by the at least one auxiliary actuator is channelled directly to the reservoir tank such that it avoids the hydraulic pump/motor.

6. A hydraulic system according to claim 3 wherein the hydraulic system further comprises a reservoir tank and is configured such that when the hydraulic lifting actuator is in the load lowering mode and it is required to simultaneously actuate the at least one hydraulic actuator, and P1 is less than P2, hydraulic flow from the hydraulic lifting actuator is channelled directly to the reservoir tank such that it avoids the hydraulic pump/motor and the hydraulic pump/motor is operated in the drive mode to actuate the at least one hydraulic actuator.

7. A hydraulic system according to claim 6 further comprising a lifting valve arranged to control the flow of hydraulic fluid to and from the hydraulic lifting actuator, wherein when the hydraulic flow from the hydraulic lifting actuator is channelled directly to the reservoir tank the lifting valve is operable to variably restrict the flow of fluid to the reservoir tank from the hydraulic lifting actuator to control to lowering speed of the hydraulic lifting actuator.

8. A hydraulic system according to claim 3 wherein when the hydraulic lifting actuator is in the load lowering mode and operation of the at least one auxiliary hydraulic actuator is not required, all the hydraulic power P2 is directed to drive the pump/motor in the regeneration mode.

9. A hydraulic system according to claim 1 wherein when it is required to simultaneously operate the hydraulic lifting actuator in the load lifting mode and operate the at least one auxiliary cylinder, both are driven by the pump/motor which operates as a pump in the drive mode.

10. A hydraulic system according to claim 9 further comprising a lifting valve for controlling flow to and from the hydraulic lifting actuator and an auxiliary valve for controlling flow to and from the auxiliary hydraulic actuator, wherein when the hydraulic lifting actuator and auxiliary hydraulic actuator are being driven by the pump/motor simultaneously and the load on the hydraulic lifting actuator is greater than the load on the auxiliary hydraulic actuator the auxiliary valve is throttled to create sufficient backpressure to enable the hydraulic lifting actuator to operate simultaneous with the auxiliary hydraulic actuator.

11. A hydraulic system according to claim 9 wherein when the hydraulic lifting actuator and auxiliary hydraulic actuator are being driven by the pump/motor simultaneously and the combined speed of the hydraulic lifting actuator and auxiliary hydraulic actuator exceeds the maximum speed of the pump/motor, operation of one of the hydraulic lifting actuator and auxiliary hydraulic actuator is prioritized and allowed to continue at the required speed while flow to the other is throttled to reduce the combined speed to a level equal to or below the speed range of the pump/motor.

12. A hydraulic system according to claim 1 wherein when the hydraulic lifting actuator is in the load lowering mode and it is required to simultaneously actuate the at least one auxiliary hydraulic actuator, and P1 is greater than P2, but the lowering speed of the hydraulic lifting actuator is less than the demand speed of the auxiliary hydraulic actuator, the hydraulic flow from the hydraulic lifting actuator may be channelled directly to the reservoir tank such that it avoids the hydraulic pump/motor and the hydraulic pump/motor is operated in the drive mode to actuate the at least one hydraulic actuator.

13. A load handling vehicle comprising a hydraulic system according to claim 1.

14. A method of operating a hydraulic system for a load handling vehicle comprising a hydraulic lifting actuator arranged and configured to operate in a load lifting mode in which a load is induced on the actuator, and a load lowering mode in which the main hydraulic actuator provides hydraulic power P1 to the hydraulic system; at least one hydraulic actuator which, when operated, has a hydraulic power demand P2; and a hydraulic pump arranged to direct hydraulic power to the hydraulic lifting actuator and the at least one auxiliary hydraulic actuator;
wherein when the hydraulic lifting actuator is in the load lowering mode and it is required to simultaneously actuate the at least one auxiliary hydraulic actuator,
and P1 is greater than or equal to P2, the method comprises actuating the at least one auxiliary hydraulic actuator by channelling hydraulic power directly to the at least one auxiliary hydraulic actuator from the hydraulic lifting actuator such that the at least one auxiliary hydraulic actuator is actuated entirely by the hydraulic power from the hydraulic lifting actuator.

15. A method according to claim 14 further comprising channelling excess hydraulic power not required by the at least one auxiliary hydraulic actuator to drive a pump/motor in the regeneration mode to generate electricity when the hydraulic lifting actuator is in the load lowering mode and it is required to simultaneously actuate the at least one auxiliary hydraulic actuator, and P1 is greater than P2.

16. A method according to claim 15 further comprising channelling excess hydraulic flow from the hydraulic lifting actuator not required by the at least one auxiliary actuator directly to a reservoir tank such that it avoids the hydraulic pump/motor reservoir tank when the hydraulic lifting actuator is in the load lowering mode and it is required to simultaneously actuate the at least one auxiliary hydraulic actuator, and P1 is greater than P2, and electrical regeneration is not required.

17. A method according to claim 15 further comprising channelling hydraulic flow from the hydraulic lifting actuator directly to the reservoir tank such that it avoids the hydraulic pump/motor and operating the hydraulic pump/motor in a drive mode to actuate the at least one hydraulic actuator when the hydraulic lifting actuator is in the load lowering mode and it is required to simultaneously actuate the at least one hydraulic actuator, and P1 is less than P2.

18. A method according to claim 17 further comprising operating a lifting valve to variably restrict the flow of fluid to the reservoir tank from the hydraulic lifting actuator to control the lowering speed of the hydraulic lifting actuator when the hydraulic flow from the hydraulic lifting actuator is channelled directly to the reservoir tank.

19. A method according to further comprising directing all the hydraulic power P2 to drive the pump/motor in the regeneration mode when the hydraulic lifting actuator is in the load lowering mode and operation of the at least one auxiliary hydraulic actuator is not required.

20. A method according to claim 15 comprising operating the pump in a drive mode to drive both the hydraulic lifting actuator and the at least one
auxiliary cylinder wherein when it is required to simultaneously operate the hydraulic lifting actuator in the load lifting mode and operate the at least one auxiliary cylinder.

21. A method according to claim 20 wherein the hydraulic system includes a lifting
valve for controlling flow to and from the hydraulic lifting actuator and an auxiliary valve for controlling flow to and from the auxiliary hydraulic actuator and the method comprises throttling the auxiliary valve to create sufficient backpressure to enable the hydraulic lifting actuator to operate simultaneously with the auxiliary hydraulic actuator when the hydraulic lifting actuator and auxiliary
hydraulic actuator are being driven by the pump/motor simultaneously and the load on the hydraulic lifting actuator is greater than the load on the auxiliary hydraulic actuator

22. A method according to claim 20 comprising prioritizing the operation of one
of the hydraulic lifting actuator and auxiliary hydraulic actuator and allowed said prioritized operation to continue at the required speed and at the same time throttling flow to the other to reduce the combined speed to a level equal to or below the speed range of the pump/motor when the hydraulic lifting actuator and auxiliary hydraulic actuator are being driven by the pump/motor simultaneously
and the combined speed of the hydraulic lifting actuator and auxiliary hydraulic actuator exceeds the maximum speed of the pump/motor.

23. A method according to claim 15 comprising channelling the hydraulic flow from the hydraulic lifting actuator directly to the reservoir tank
such that it avoids the hydraulic pump/motor and operating the hydraulic pump/motor in the drive mode to actuate the at least one hydraulic actuator when the hydraulic lifting actuator is in the load lowering mode and it is required to simultaneously actuate the at least one auxiliary hydraulic actuator, and P1 is greater than P2, but the lowering speed of the hydraulic lifting actuator is less than the demand speed of the auxiliary hydraulic actuator.

24. A hydraulic system for a load handling vehicle, the system comprising
a hydraulic lifting actuator arranged and configured to operate in a load lifting mode and a load lowering mode in which a load is induced on the hydraulic lifting actuator;
at least one auxiliary hydraulic actuator which, when operated, has a pressure demand; and
a hydraulic pump arranged to direct hydraulic power to the hydraulic lifting actuator and the at least one auxiliary hydraulic actuator;
wherein the hydraulic system is configured such that when the hydraulic lifting actuator is in the load lowering mode, and it is required to simultaneously actuate the at least one auxiliary hydraulic actuator, the induced pressure on the hydraulic lifting actuator may be used to operate the at least one auxiliary hydraulic actuator if the induced pressure is greater than or equal to the demand pressure.
